(19) United States
(12) Patent Application Publication
(10) Pub. No.: US 2005/0034108 A1
(43) Pub. Date: Feb. 10, 2005

(54) Processing instructions

(76) Inventors: Erik J. Johnson, Portland, OR (US); James L. Jason JR., Hillsboro, OR (US); Steve D. Goglin, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/641,614

(22) Filed: Aug. 15, 2003

Related U.S. Application Data
(62) Division of application No. 09/898,279, filed on Jul. 3, 2001, now Pat. No. 6,673,810.
Application No. 09/898,279 is a continuation-in-part of application No. 09/470,326, filed on Dec. 22, 1999, now Pat. No. 6,413,980.
(60) Provisional application No. 60/127,633, filed on Apr. 2, 1999.
(60) Provisional application No. 60/113,628, filed on Dec. 23, 1998.

(51) Int. Cl. G06F 9/45

(52) U.S. Cl. 717/136; 717/141

(57) ABSTRACT

In general, in one aspect, the disclosure describes a computer program to access a set of source instructions and identify a variable within the source instructions to be accessed by different threads. The program determines a location within the execution flow specified by the set of source instructions, where the variable value, after the determined flow location, has an unchanging value. The program generates at least one set of target instructions for the source instructions. The target instructions copy the value of the variable from a first memory to a second memory based on the determined location. The generated target instructions access the copy of the value in the second memory for at least one source instruction that specifies access to at least one variable.

### BACKGROUND

A recent trend in processor technology has been a move towards including multiple processing engines on a single die. As an example, some network processors feature multiple packet engines that simultaneously execute different packet processing threads. For instance, while one engine executes a thread to determine how to forward one packet further toward its destination, a different engine executes a thread to determine how to forward another.

To program the engines, programmers often use a tool known as a compiler. The compiler can translate source code into lower level assembly code or even the “1”-s and “0”-s of engine executable instructions. For example, a programmer can use a compiler to turn high-level “C” source code of
next_hop=route_lookup(packet.destination_address);
into a series of lower-level instructions executable by an engine. A compiler can also “pre-process” source code by replacing the source code instructions with other source code instructions, for example, to improve code written by a programmer.

Software written to take advantage of the potential strengths of a multiple engine architecture can offer superior performance. Often, however, the burden of efficiently using resources within a complex parallel computing environment has been placed on the programmer.

### BRIEF DESCRIPTION OF THE DRAWINGS

FIG. 1 is a diagram illustrating operation of a compiler.

FIG. 2 is a diagram illustrating different sets of instructions generated by a compiler.

FIG. 3 is a diagram illustrating instructions that copy a variable from shared memory.

FIG. 4 is a flow-chart of a process to identify variables to copy from shared memory.

FIG. 5 is a diagram of a network processor.

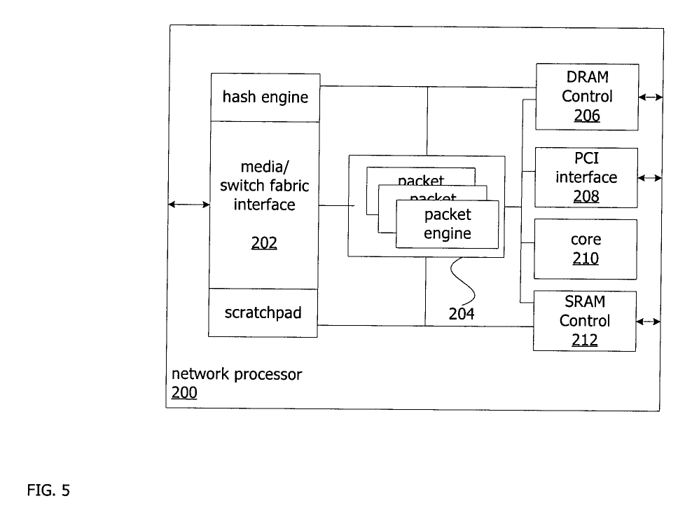

### DETAILED DESCRIPTION

The memory used to store data often has a significant impact on how quickly a program operates. For example, a multiple engine processor, such as a network processor, may provide memory shared by different engines. This shared memory can be used to store variables accessed by threads executing on the engines. Shared memory provides a convenient inter-thread/inter-engine communication mechanism. However, using shared memory to store a variable may introduce delays, for example, as the different threads contend with one another for access to the memory storing the variable.

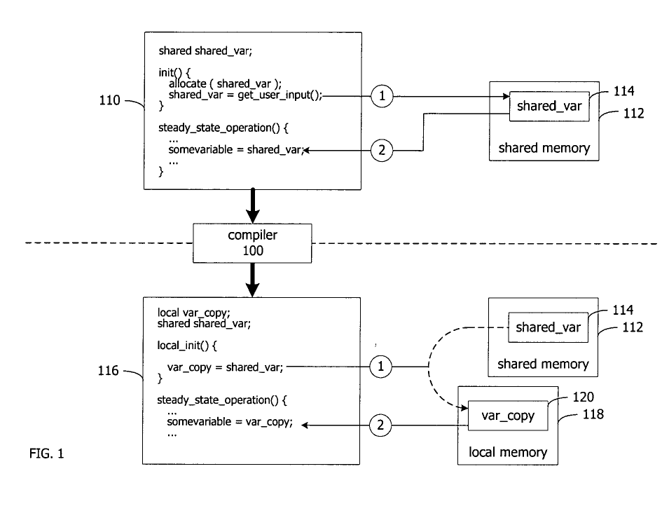

FIG. 1 illustrates operation of a compiler 100 that can process instructions 110 to reduce shared memory access requested by different threads without altering program functionality 110. As shown in FIG. 1, the compiler 100 operates on source code 110 to produce target code 116. In the example, shown, the source code 110 defines a variable, “shared_var”, and includes instructions that (1) write a value to the variable. In this example, the value written to the variable is not determined during compilation. The source code 110 also includes instructions that later (2) read the variable value. Potentially, the same program 110 may be intended for independent execution by different threads. Thus, many threads executing the program 110 may each read the variable value.

Potentially, the compiler 100 could simply generate instructions that allocate a portion of shared memory 112 to store shared_var 114 and repeatedly access the shared memory. However, repeated accesses of shared memory may slow thread execution due to the latency penalty associated with each shared memory 114 access. Additionally, since the resulting instructions may be executed by many different threads, this latency penalty may be endured many times over.

As shown in FIG. 1, instead of leaving the program to access shared memory 112 again and again, the compiler 100 can generate instructions 116 that (1) copy the value of the variable 114 from shared memory 112 at, or after, a point in the execution flow of program 110 where the compiler 100 determines that the variable value will, thereafter, remain constant. As shown, once copied, the compiler 100 can replace instructions that access the variable value with instructions that (2) access the copy instead. Though the copy operation imposes a fixed, initial processing cost, repeated accesses to the variable within the program and across threads executing the program will generally improve overall execution speed.

As shown in FIG. 1, the generated instructions 116 copy shared_var to memory 118. Memory 118 may be a memory uniquely associated with an engine (e.g., an engine memory cache) or may be some other memory with a lower latency than memory 114 with respect to a thread executing the generated instructions 116.

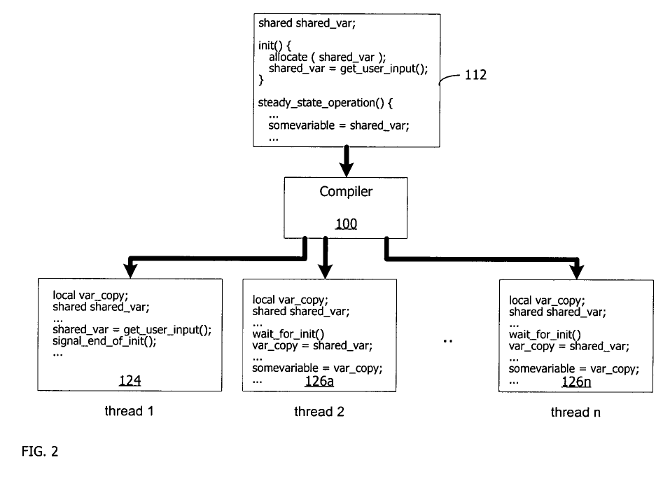

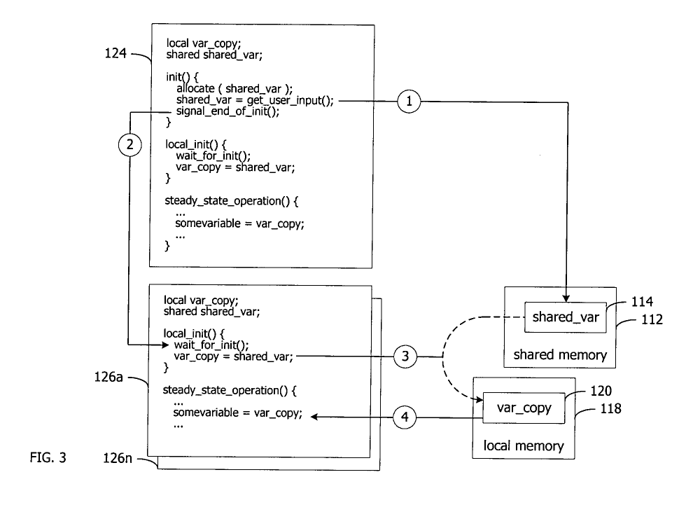

As shown in FIG. 2, the compiler 100 may generate different sets of instructions 124, 126a-126n from the same source code 116. The sets of instructions 124, 126a-126n may be processed by different engines and/or by different engine threads. As shown, the instructions generated by the compiler 100 may vary. FIG. 3 illustrates an example of this in greater detail.

As shown in FIG. 3, a first set of instructions 124 generated by the compiler 110 includes instructions that specify (1) write operations to the variable 114 in shared memory 112. The first set 124 also includes instructions that (2) notify other threads after the variable 114 assumes a non-changing value. Assuming the write operations were only intended to be executed once for all threads (e.g., as part of thread initialization), the remaining instruction sets 126a-126n need not include the write operations of the first set 124. Instead the remaining sets 126a-126n include instructions that (3) copy the variable 114 after awaiting (or polling) for notification. Thereafter, the sets 126a-126n can (4) access the copy instead of the actual variable in shared memory 112.

FIGS. 1-3 illustrated the compiler 100 output 116, 124, 126 in the same instruction set as the source code. That is, the compiler 100 output shown is in the same “C”-like instruction set as the source. While this is possible when the compiler 100 operates as a source code pre-processor, the actual output may instead be in a lower level instruction set such as assembly code or engine executable code expressed in the engine's instruction set.

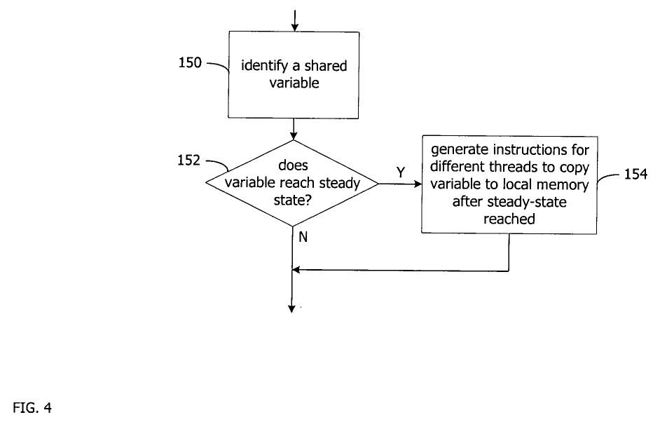

FIG. 4 illustrates a process implemented by a compiler using techniques described above. As shown, the compiler identifies 150 a variable to be accessed by different threads included in source code. A variable may be explicitly (e.g., declared “global” or “shared”) or implicitly declared (e.g., by the location of the declaration or by references to the variable or the variable's address) as being shared by different threads.

For such variables, the compiler determines 152 whether the variable assumes a constant value after a certain point in program execution. Such a determination may be made by data-flow analysis (e.g., by identifying instructions that access the variable or a variable alias). Alternately, the source code may include an instruction to declare the onset of an unchanging variable value (e.g., “read_only(shared_variable)”) or may reserve a section of code (“init( ){ }”) to set the values of variables that remain constant thereafter.

For such variables, the compiler can generate 154 instructions that, first, copy the variable to a lower latency memory with respect to the executing thread and, subsequently, replace read accesses of the variable to read accesses of the copy.

Techniques described above may be used by compilers for a variety of multi-engine systems. For example, techniques described above may be implemented by a compiler for a network processor. Many network processor architectures feature multiple engines that process packets, for example, by classifying the packets, determining where to forward the packets, applying Quality of Service (QoS), and so forth. Since two packets may have little relation to one another (e.g., they may be part of a different flow between different network end points), network processors often do not feature hardware support for caching frequently accessed data. Thus, techniques described above can effectively cache shared variables in engine or thread local memory (or at least lower latency memory) even in the absence of caching hardware support.

As an example of a network processor, FIG. 7 depicts an Intel® Internet eXchange network Processor (IXP). Other network processors feature different designs.

The network processor 200 shown features a core 210 processor (e.g., a StrongARM® XScale®) and a collection of packet engines 204 that provide a collection of threads to process packets. The packet engines 204 may be Reduced Instruction Set Computing (RISC) processors tailored for packet processing. For example, the packet engines 204 may not include floating point instructions or instructions for integer multiplication or division commonly provided by general purpose processors.

An individual packet engine 204 may offer multiple threads. For example, a multi-threading capability of the packet engines 204 may be supported by hardware that reserves different registers for different threads and can quickly swap thread execution contexts (e.g., program counter and other execution register values). In some network processors, such as the IXP shown, an engine executes the same instruction set for each thread. That is, the same program is independently executed by the threads of the engine.

A packet engine 204 may feature local memory that can be accessed by threads executing on the engine 204. The network processor may also feature different kinds of memory shared by the different engines 204. For example, the shared “scratchpad” provides the engines with fast on-chip memory. The processor also includes controllers to external Static Random Access Memory (SRAM) and higher-latency Dynamic Random Access Memory (DRAM). Thus, the compiler could allocate storage for a variable in the shared scratchpad, SRAM, or DRAM, and copy the variable into packet engine memory for threads accessing the variable after it assumes an unchanging value.

As shown, the network processor 200 features other components including interfaces 202 that can carry packets between the processor 200 and other network components. For example, the processor 200 can feature a switch fabric interface 202 (e.g., a CSIX interface) that enables the processor 200 to transmit a packet to other processor(s) or circuitry connected to the fabric. The processor 200 can also feature an interface 202 (e.g., a System Packet Interface Level 4 (SPI-4) interface) that enables to the processor 200 to communicate with physical layer (PHY) and/or link layer devices. The processor 200 also includes an interface 208 (e.g., a Peripheral Component Interconnect (PCI) bus interface) for communicating, for example, with a host.

As described above, the techniques may be implemented by a compiler. In addition to the compiler operations described above, the compiler may perform other compiler operations such as lexical analysis to group the text characters of source code into “tokens”, syntax analysis that groups the tokens into grammatical phrases, semantic analysis that can check for source code errors, intermediate code generation (e.g., WHIRL) that more abstractly represents the source code, and optimizations to improve the performance of the resulting code. The compiler may compile an object-oriented or procedural language such as a language that can be expressed in a Backus-Naur Form (BNF).

Other embodiments are within the scope of the following claims.

1. A computer program product, disposed on a computer readable medium, the program including program instructions for causing a processor to:
access a set of source instructions;
identify at least one variable within the source instructions, the variable to be accessed by different threads;
determine a location within the execution flow specified by the set of source instructions, wherein the at least one variable value, after the determined flow location, has an unchanging value; and
generate at least one set of target instructions for the source instructions, wherein at least one of the sets of target instructions includes instructions to:
copy the value of the variable from a first memory to a second memory at a location within the execution flow of the target instructions based on the determined location; and
access the copy of the value in the second memory for at least one source instruction that specifies access to the at least one variable.

2. The program of claim 1, wherein the program instructions to generate at least one set of target instructions comprise program instructions to generate a first of the set of target instructions to notify a second of the set of target instructions to copy the variable.

3. The program of claim 1,
wherein the first memory comprises a memory shared by different engines in a multi-engine system, the memory not uniquely associated with a particular one of the different engines; and
wherein the second memory is the local memory of an engine.

4. The program of claim 1, wherein the first memory has a greater latency than the second memory with respect to a thread to execute a one of the set of the target instructions.

5. The program of claim 1, wherein the determining the location comprises performing data-flow analysis of the at least one variable value.

6. The program of claim 1, wherein at least one set of target instructions comprises target instructions of a packet engine of a network processor.

7. The program of claim 6, wherein the at least one set of target instructions comprises multiple sets of target instructions.

8. The program of claim 1,
wherein the program comprises a compiler; and
wherein the source instructions comprise instructions expressed in a higher level language than the target instructions.

9. The program of claim 1, wherein the unchanging value of the at least one variable is not determined during compilation.

10. A method, comprising:
accessing a set of source instructions;
identifying at least one variable within the source instructions, the variable to be accessed by different threads;
determining a location within the execution flow specified by the set of source instructions, wherein the at least one variable value, after the determined flow location, has an unchanging value; and
generating at least one set of target instructions for the source instructions, wherein at least one of the sets of target instructions includes instructions to:
copy the value of the variable from a first memory to a second memory at a location within the execution flow of the target instructions based on the determined location; and
access the copy of the value in the second memory for at least one source instruction that specifies access to the at least one variable.

11. The method of claim 10, wherein the program instructions to generate at least one set of target instructions comprise program instructions to generate a first of the set of target instructions to notify a second of the set of target instructions to copy the variable

12. The method of claim 10,
wherein the first memory comprises a memory shared by different engines in a multi-engine system, the memory not uniquely associated with a particular one of the different engines; and
wherein the second memory is the local memory of an engine.

13. The method of claim 10, wherein the first memory has a greater latency than the second memory with respect to a thread to execute one of the set of the target instructions.

14. The method of claim 10, wherein the determining the location comprises performing data-flow analysis of the at least one variable value.

15. The method of claim 10, wherein the at least one set of target instructions comprise target instructions of a packet engine of a network processor.

16. The method of claim 15, wherein the at least one set of target instructions comprises multiple sets of target instructions.

17. The method of claim 10, wherein the source instructions comprise instructions expressed in a higher-level language that the target instructions.

18. A compiler, disposed on a computer readable medium, the program including program instructions for causing a processor to:
access a set of source instructions;
identify at least one variable within the source instructions, the variable to be accessed by different network processor engine threads;
determine a location within the execution flow specified by the set of source instructions, wherein the at least one variable value, after the determined flow location, has an unchanging value; and
generate multiple sets of target instructions for the source instructions, wherein at least one of the sets of target instructions includes instructions to:
copy the value of the variable from a first memory to a second memory at a location with the execution flow of the target instructions based on the determined location; and
access the copy of the value in the second memory for at least one source instruction that specifies access to the at least one variable;
wherein the first memory comprises a memory shared by different engines in a multi-engine system, the memory not uniquely associated with a particular one of the different engines;
wherein the second memory is the local memory of an engine in the multi-engine system; and
wherein the source instructions comprise instructions expressed in a higher level language that the target instructions.

19. The compiler of claim 18, wherein the target instructions comprise instructions expressed in an instruction set of a packet engine.
